(19) United States
(12) Patent Application Publication
(10) Pub. No.: US 2015/0317145 A1
(43) Pub. Date: Nov. 5, 2015

(54) METHOD AND APPARATUS FOR NOTIFYING AN ENTERPRISE ADMINISTRATOR OF NEW PRODUCTS AND UPDATES

(71) Applicant: Adobe Systems Incorporated, San Jose, CA (US)

(72) Inventors: Saransh Katariya, Indore (IN); Mansukh Patidar, Greater Noida (IN)

(73) Assignee: Adobe Systems Incorporated, San Jose, CA (US)

(21) Appl. No.: 14/266,141

(22) Filed: Apr. 30, 2014

(51) Int. Cl. G06F 9/445; G06Q 30/02

(52) U.S. Cl. CPC G06F 8/65; G06F 8/61; G06Q 30/0241

(57) ABSTRACT

A computer implemented method and apparatus for notifying an enterprise administrator of new products and updates. The method comprises displaying one or more software packages on a first device, where each of the one or more software packages is installed on one or more end user devices, each end user device being remote from the first device, and each software package comprising one or more products; indicating each product in the one or more software packages that has on or more new products or one or more new updates available based on information from a software provider of the one or more products; receiving a selection of the one or more software packages for updating; downloading each of the one or more products in each of the one or more selected software package to the first device; and bundling the one or more downloaded products to create a software package for installation on the one or more end user devices.

### BACKGROUND OF THE INVENTION

1. Field of the Invention

Embodiments of the present invention generally relate to software packaging and, more particularly, to techniques for notifying an enterprise administrator of new products and updates.

2. Description of the Related Art

An enterprise administrator manages hardware and software on end user devices for their organization. The enterprise administrator decides what software is required for a group in their organization and installs the appropriate software on each end user's computer. For example, an accounting department may require billing software, payroll software, word processing software, and email software. An engineering department may require various software development kits, and email software. As such, the enterprise administrator is responsible for downloading and packaging software, and then installing on the end user's computer. Once installed, the enterprise administrator is responsible for keeping all software applications on all end user computers up-to-date. Typically, when an end user has one or more applications on the end user's computer, the end user is notified when a new version of an application is available for download. However, enterprise administrators are not provided with these update notifications because the software is not installed on the enterprise administrator's computer. An enterprise administrator must keep track of what applications are installed on which end user computers and manually check to see if each application has a new version available for download. In addition, the enterprise administrator must manually look for additional software that may be available for use by one or more groups within the organization. This manual bookkeeping causes unnecessary time to be wasted. Therefore, there is a need for a method and apparatus for notifying an enterprise administrator of new products and updates.

### SUMMARY OF THE INVENTION

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for notifying an enterprise administrator of new products and updates is described. The method displays one or more software packages on a first device, where each of the one or more software packages is installed on one or more end user devices. Each end user device is remote from the first device, and each software package comprising one or more products. The method indicates each product in the one or more software packages that has a new product or update available. The new product or update is based on information from a software provider of the one or more products or one or more new updates. The method receives a selection of the one or more software packages to be updated. The method downloads the one or more products in the selected software package to the first device. The method then bundles the one or more downloaded products to create a software package for installation on the one or more end user devices.

In another embodiment, an apparatus for notifying an enterprise administrator of new products and updates is described. The apparatus includes a packager module for interfacing with a software provider server. The packager module displays one or more software packages on a first device, where each of the one or more software packages is installed on one or more end user devices. Each end user device is remote from the first device, and each software package comprising one or more products. The packager module indicates each product in the one or more software packages that has a new product or update available. The new product or update is based on information from a software provider of the one or more products or updates. The packager module receives a selection of the one or more software packages to be updated. The packager module downloads the one or more products in the selected software package to the first device. The packager module then bundles the one or more downloaded products to create a software package for installation on the one or more end user devices.

In yet another embodiment, a computer readable medium for notifying an enterprise administrator of new products and updates is described. The computer readable medium stores computer instructions that, when executed by at least one processor causes the at least one processor to perform the method for notifying an enterprise administrator of new products and updates.

### BRIEF DESCRIPTION OF THE DRAWINGS

FIG. 1 is a block diagram of a system for notifying an enterprise administrator of new products and updates, according to one or more embodiments;

FIG. 2 depicts a flow diagram of a method for notifying an enterprise administrator of new products and updates as performed by the packager module of FIG. 1, according to one or more embodiments;

FIG. 3 depicts a flow diagram for a method for displaying new products and updates available from a software provider, as performed by the packager module of FIG. 1, according to one or more embodiments;

FIG. 4 illustrates a screen shot of a window for displaying new products and updates that have not been viewed by the user, according to one embodiment; and

FIG. 5 illustrates a screen shot of a window for displaying software packages with available updates, according to one embodiment.

While the method and apparatus is described herein by way of example for several embodiments and illustrative drawings, those skilled in the art will recognize that the method and apparatus for notifying an enterprise administrator of new products and updates is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for notifying an enterprise administrator of new products and updates defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for notifying an enterprise administrator of new products and updates. The embodiments provide an interface tool that enables an administrator to interface with a server of a software provider. The interface tool maintains a history of all applications that an enterprise administrator, hereafter referred to as an administrator, has viewed or downloaded. When an administrator logs into the server from the administrator's computer, the administrator is provided a list of all new products and updates that have become available from the software provider. In addition, the interface tool determines whether any software applications that the administrator has downloaded in the past have an update or a new version available for download. The interface tool displays all previously packaged software with available updates for each package. The administrator may select a package from the display. The new or updated software versions for the applications in the selected package are downloaded from the software provider's server to the administrator's computer. The downloaded software is then packaged on the administrator's computer for download to one or more end user devices.

As previously explained, existing solutions require an administrator to manually track what software has been installed on a plurality of end user devices. An administrator must then manually check whether a new version of any of the software has been released from the software provider. In addition, existing solutions provide no automated means of being notified of what new software products are available and which of the new software products the administrator has already viewed.

Thus, and in accordance with an embodiment of the present invention, techniques are provided herein that allow for notifying an administrator of new products and updates. When the administrator registers with a software provider, a packager module is downloaded from the software provider server and installed on an administrator's computer. The packager module is a tool that interfaces with the software provider server. The administrator launches the tool and logs into the server. An administrator's account at the software provider server includes a listing of what software products and updates the administrator has viewed in the past. The software provider often has new products, or updates, that become available. Periodically, the administrator reviews the products and updates that are available. The administrator decides which products or updates are of interest and which are not. For example, the administrator may review a software product, but decide that it does not meet her current needs. The administrator does not want to see the same software product that she has already seen before. However, if an update to the software product becomes available that includes functionality that the administrator needs, the administrator wants to be notified when the update is available. As such, the listing of what the administrator has viewed in the past is used to ensure only new products and updates that the administrator has not viewed before are displayed to the administrator.

The administrator's account on the server also includes a listing of software packages that the administrator has downloaded from the server. The administrator needs to be notified when a new version or update of a software application that the administrator has installed on an end user device becomes available. The listing of software packages is maintained such that when the administrator logs into the server, the list can be compared to software products and updates that are currently available and identify what software products in the packages are not up-to-date.

When the administrator logs into the server, the packager module retrieves metadata from the administrator's account that identifies all software products and updates that the administrator has viewed. The packager module then retrieves a list from the software provider that identifies all new products and updates that are available from the software provider. The packager module compares the new products and updates to the products and updates that the administrator has already seen. The packager module then displays a listing of the new products and updates that have not been viewed by the administrator. In some embodiments, the listing of products and updates is fully customized. In such embodiments, search criteria, for example a date, may be entered such that all products and updates made available since the provided date are displayed to the administrator. In another example, a product may be entered such that all releases of the product and updates for the product are displayed. The administrator may select any product or update in the list and view information about the listed product. The packager module sends a message to the server to record the products and updates that were viewed by the administrator.

The packager module retrieves metadata from the administrator's account that identifies all software packages that the administrator has downloaded from the software provider. Each software package may include one or more software products in addition to one or more updates. For example, a software package may include the products ADOBE Muse CC and Edge Animate, and an update for ADOBE Bridge CC. The packager module compares the products updates in the software package to the list of all new products and updates that have become available from the software provider. If there are any products or updates in the software package that have newer versions available, the packager module displays the software package with a list of products and updates that are newly available from the software provider. The administrator may select a software package to update, which causes the products and updates of the software package to be downloaded from the server with the products and updates that are newly available. The downloaded products and updates are then bundled for installation on an end user device. The package module then sends metadata to the server to store the updated software package in the administrator's account.

As used herein, in addition to publicly known or dictionary meaning, a software package is one or more software programs or updates bundled together for download to an end user device. The term “product”, as used herein, refers to software applications as well as software updates. New software products are new versions of software products that include the software product in its entirety. The new version may have new, modified, or deleted features. A new update is software that may replace a portion of a software product, for example, to fix a problem with a feature of the software or improve processing time that updates less than all of the software product. The term “update” when used as a noun refers to software that replaces a portion of a software product, as just described. The term “update” when used as a verb refers to replacing one or more software products and/or one or more software updates with newer available versions of the same in a software package.

Advantageously, the present invention may be implemented to interface with a software provider to notify administrators when new software products and updates are available for download. The interface tool frees the administrator from manual bookkeeping of software updates, saving the administrator time and providing a user-friendly experience.

Various embodiments of a method and apparatus for notifying an enterprise administrator of new products and updates are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

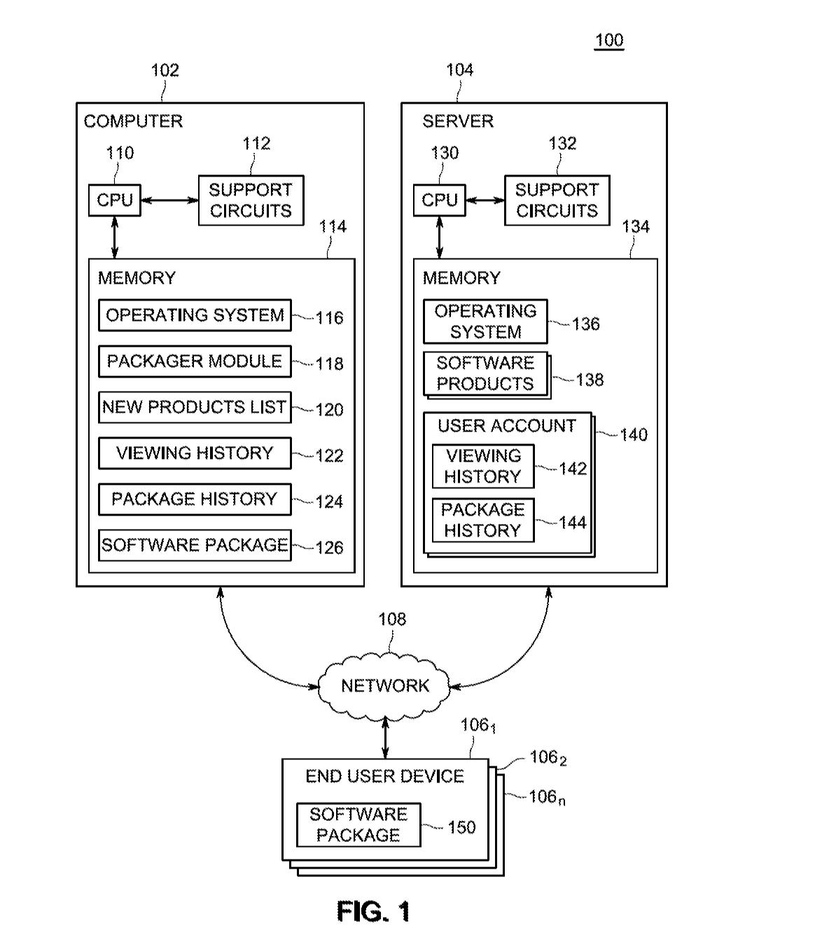

FIG. 1 is a block diagram of a system 100 for notifying an enterprise administrator of new products and updates, according to one or more embodiments. The system 100 includes a computer 102, a server 104, and a plurality of end users devices 106₁, 106₂, . . . , 106ₙ, collectively referred to as end user device 106, communicatively coupled to one another via a network 108. The computer 102 is an administrator computer, used by an administrator for bundling a software package 126 on the computer 102 and downloading the software package 126 to an end user device 106. The computer 102 is a computing device, for example a desktop computer, laptop, tablet computer, smartphone and the like. The administrator computer 102 includes a Central Processing Unit (CPU) 110, a memory 114 and support circuits 112. The CPU 110 may include one or more commercially available microprocessors or microcontrollers that facilitate data processing and storage. The various support circuits 112 facilitate the operation of the CPU 110 and include one or more clock circuits, power supplies, cache, input/output circuits, and the like. The memory 114 includes at least one of Read Only Memory (ROM), Random Access Memory (RAM), disk drive storage, optical storage, removable storage and/or the like.

The memory 114 includes an operating system 116, a packager module 118, a new products list 120, a viewing history 122, a package history 124, and a software package 126. The operating system 116 may include various commercially known operating systems.

The server 104 is a software provider server. The server 104 is a computing device, for example a desktop computer, laptop, tablet computer, smartphone and the like. The software provider server 104 includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like.

The memory 134 includes an operating system 136, a plurality of software products 138, and a plurality of user accounts 140. Each user account includes a viewing history 142 and a package history 144. The operating system 136 may include various commercially known operating systems.

The packager module 118 is a tool for interfacing computer 102 with the server 104, for example an ADOBE® Creative Cloud™ Packager 118 that interfaces with the ADOBE® Creative Cloud™ server 104.

The end user device 106 is a computing device, for example a desktop computer, laptop, tablet computer, smartphone and the like. The end user device includes one or more software packages 150 that have been downloaded from the administrator computer 102 and installed on the end user device 106.

The network 108 includes a communication system that connects computers (or devices) by wire, cable, fiber optic and/or wireless link facilitated by various types of well-known network elements, such as hubs, switches, routers, and the like. The network 108 may be a part of the Intranet using various communications infrastructure, such as Ethernet, Wi-Fi, a personal area network (PAN), a wireless PAN, Bluetooth, Near field communication, and the like.

An enterprise administrator, hereafter referred to as a user, on the computer 102 downloads the packager module 118 from the server 104. The packager module 118 is one of the plurality of software products 138 on the server 104. The user launches the packager module 118 and is prompted to log into the server 104. The user's login is associated with a user account 140 on the server 104. The user account 140 includes a viewing history 142 and a package history 144 for the user. The viewing history 142 identifies what products and updates have been viewed by the user. The package history 144 identifies what packages were downloaded by the user to the computer 102.

The packager module 118 sends a request to the server 104 to retrieve the viewing history 142 from the user account 140. The viewing history 142 is sent from the server 104. A list of new products and updates that are available from the software provider is sent with the viewing history 142 and stored by the packager module 118 as new products list 120. The packager module 118 compares the viewing history 142 with the new products list 120. If there are any products or updates in the new products list 120 that are not listed in the viewing history 142, it means there are new products and updates that are available from the software provider that have not been viewed by the user. In some embodiments, the identification of new products and updates that have not been viewed is performed on the server 104 and the list is sent to the packager module 118. The packager module 118 displays new products and updates that have not been viewed. The user may select one or more of the products or updates in order to view more information. When a user views more information about a product or update, the viewing history 142 is updated to include the product or update that was viewed. The viewing history 142 is then sent back to the server 104 to store in the user account 140.

The packager module 118 sends a request to the server 104 to retrieve the package history 144 from the user account 140 of the user. The package history 144 includes one or more software packages that the user has downloaded from the server 104. In one example, the package history 144 includes two software packages. A first software package includes ADOBE Muse CC v6.0, Edge Animate v.1.5, and an update to ADOBE Bridge CC 6.0.1. A second software package includes Gaming SDK v1.2, Edge Reflow CC v1.0, and an update to ADOBE Audition CS6.

The packager module 118 displays each software package that is included in the package history 144. The packager module 118 compares each product in each software package in the package history 144 to the new products list 120 in order to identify whether any new versions or updates to one or more products in the software package are available. If a new version or update is available for a product in the software package, the new version or update is displayed. For example, there is an update ADOBE Bridge CC 6.0.2, a version of ADOBE Muse CC v7.0, and a version of Gaming SDK v1.3. The packager module 118 displays the new versions and/or updates with the displayed software packages.

The user may then select a software package from the list. When the software package is selected, the packager module 118 downloads the software products and updates listed in the software package. The downloaded software products and updates include a most recent version of each software product and update. The packager module 118 updates the package history 124 with the new products and sends the package history 124 to the server 104 to be stored as package history 144 in the user account 140. The packager module 118 then bundles the software products and updates to create the software package 126 that may then be downloaded by the end user device 106 and installed on the end user device 106 as software package 150. As such, no manual bookkeeping of software product and updates is required of the user. In addition, the user does not have to seek out what new versions of software or updates are available from the software provider. Additionally, the user does not waste time viewing software and updates that the user has previously viewed.

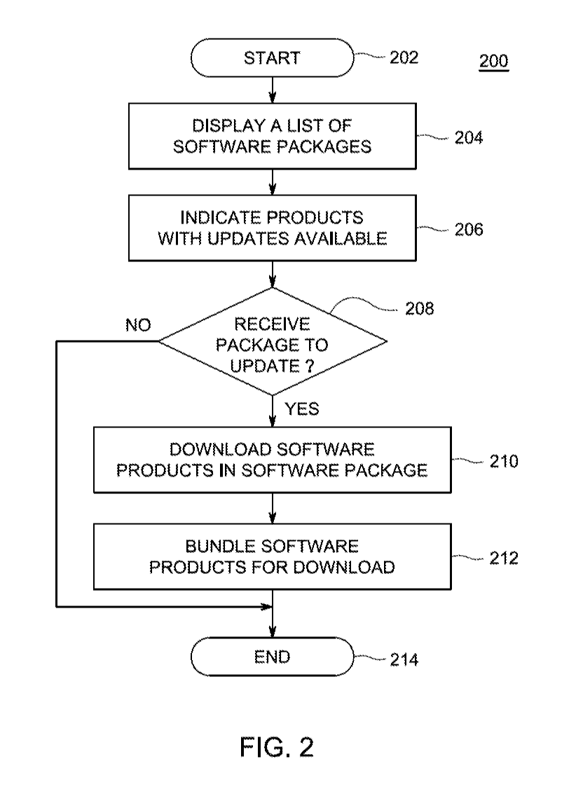

FIG. 2 depicts a flow diagram of a method 200 for notifying an enterprise administrator of new products and updates, as performed by the packager module 118 of FIG. 1, according to one or more embodiments. The method 200 is initiated when a user signs into a server of a software provider using the packager module 118. The method 200 starts at step 202 and proceeds to step 204.

At step 204, the method 200 displays a list of software packages that a user has downloaded from the software provider. The software provider maintains a package history for the user. The package history is a data structure that holds metadata for identifying one or more software packages that the user has downloaded. The data structure may be formatted as follows:
{SignInData, {PackageData[n]}}
where SignInData-->{email, username, country, last login time, other relevant information}, and
PackageData [ ] is an array representing a software package of products and updates created by the user for end user devices.

The PackageData may be formatted as follows:
PackageData→{PackageIdentifier, Organization Data, ProductsMetatdata[n], UpdatesMetadata[n]}
where PackageIdentifier-->{PackageID, PackageName, SavedLocation, Platform, other relevant data},
OrganizationData-->{organizationID, organizationName, country, other relevant information},
ProductsMetadata[n]-->array of {productIdentifier, productName, productVersion, productLanguage, Platform}, where each element refers to one product bundled in a software package, and
UpdatesMetadata[n]-->array of {updateIdentifier, updateName, updateVersion, updateLanguage, Platform}, where each element refers to one update bundled in a software package.

The productIdentifier is a unique identifier for a particular version of a product. The productName is the display name of the product. The productVersion is the version of the product. The productLanguage is the identifier of a language of the product. The product Platform is the underlying software application for the product. Similarly, the updateIdentifier is a unique update identifier for a particular version of an update. The updateName is the name of the update. The updateVersion is the version of the update. The updateLanguage is the language identifier of the update. The update Platform is the underlying software application for the update. The method 200 sends a request to the software provider server to retrieve the package history. For example, the method 200 calls a getAdminHistory API that returns the PackageData[n], which represents an entire history of what software packages the user has downloaded. The API may also return organization information, if specified.

Thus, at step 204, the method 200 displays a listing of the software packages identified from the PackageData. In some embodiments, the method 200 displays, for each software package, the package name, organization, and product list.

The method 200 proceeds to step 206, where the method 200 indicates each product in each software package that has new product versions or updates available. The method 200 sends a request to the software provider server to retrieve all new products and updates that are available from the software provider. For example, the method 200 requests a list of all new products and updates that are available from the software provider. The method 200 compares the new available products and updates with each product and update in the software packages in the PackageData. If any new products or updates are available for any products and updates in the software package, the method 200 provides an indication of what new products and updates are available. In some embodiments, the method 200 lists new products available for each software package. If a software package is up-to-date, the method 200 displays a message, for example, “No new Products or Updates available”. In some embodiments, the method 200 provides an indication, for example, by highlighting or displaying in bold, a product or update that has an update available. The method 200 may use any type of indicator to identify to a user what products and updates are available.

The method 200 proceeds to step 208, where the method 200 determines whether the user wishes to replace products or updates in a software package with new available versions. A user may select one or more software packages and when all selections are made the user may click, for example, a “DONE” button to indicate that all selections have been made. The method 200 determines whether one or more software packages have been selected. If no software packages have been selected, the method 200 proceeds to step 214 and ends.

However, if at step 208, the method 200 determines that one or more software packages have been selected, the method 200 proceeds to step 210.

At step 210, the method 200 downloads the products in the software package. The method 200 initiates download of the products in the software package. The products are the most current products that include a latest version of each product and update. The method 200 then updates the package history to include the downloaded versions. The method 200 then sends the package history to the server. For example, the method 200 calls a recordAdminHistory API that causes the server to store the updated package history in the user's account.

The method 200 proceeds to step 212, where the method 200 bundles the downloaded software products for download to an end user device. The method 200 performs a build of the downloaded software products and updates. The build creates a single software package from the various downloaded software products and updates such that the software package may be installed as a single unit on an end user device.

The method 200 proceeds to step 214 and ends.

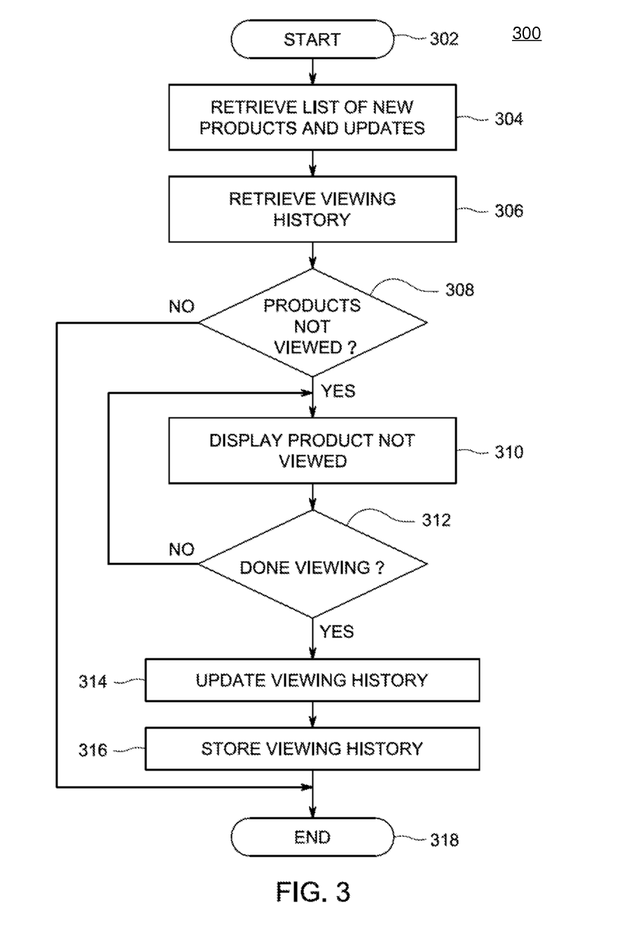

FIG. 3 depicts a flow diagram for a method 300 for displaying new products and updates available from a software provider, as performed by the packager module 118 of FIG. 1, according to one or more embodiments. In one embodiment, the method 300 is performed upon sign-in to a server using the packager module 118 before the method 200 is initiated. The method 300 starts at step 302 and proceeds to step 304.

At step 304, the method 300 retrieves a list of new products and updates that are available from the software provider. The method 300 sends a request to the software provider server for a list of new products and updates that are available from the software provider. In response to the request, the method 300 receives all new software products and updates that are available from the software provider. New software products are new versions of software products that include the software product in its entirety. The new version may have new, modified, or deleted features. A new update is software that may replace a portion of a software product, for example, to fix a problem with the software or improve processing time, that updates less than all of the software product.

The method 300 proceeds to step 306, where the method 300 retrieves a viewing history for the user. The method 300 sends a request to the software provider server to retrieve the viewing history. For example, the method 300 calls a getProductsNUpdatesMetadata API that returns metadata which represents an entire history of what software products and updates the user has seen. The viewing history is a data structure, for example, in a format as follows:
{SignInData, {ProductsMetadata[m]},{UpdatesMetadata[n]}
where SignInData-->{email, username, country, last login time, other relevant information}, and
ProductsMetadata[n]-->array of {ProductIdentifier, productName, productVersion, productLanguage, Platform}, where each element represents a product viewed by the user, and
UpdatesMetadata[n]-->array of {UpdateIdentifier, updateName, updateVersion, updateLanguage, Platform}, where each element represents an update viewed by the user.

An example of a viewing history is as follows:
{{JSmith@adobe.com, John Smith, India, 12/11/12 11.20.50 pm}. {{PHSP_{—}13.0.2_en_US, Adobe Photoshop CC, 13.0.2,en_US,win64},{AUDT_{—}7.2.1_fr_FR, Adobe Audition CS6, 7.2.1, fr_FR, win64}}, {{PhotoShopCameraRaw_{—}13.1.1_mul, Photoshop Camera Raw 13.1.1, 13.1.1, all, macOS}, {CSXSExtentionManager_{—}4.0_mul, Adobe CSXS extension, 4.0, all, macOS}}

The sample viewing history shows all products and updates that John Smith has viewed. John Smith viewed the products ADOBE PHOTOSHOP CC, version 13.0.2 for the English language and a WINDOWS platform in addition to ADOBE Audition CS6, version 7.2.1 for the French language and a WINDOWS platform. John Smith also viewed updates. Specifically, John Smith viewed PHOTOSHOP Camera Raw version 13.1.1 for a macOS platform and ADOBE CSXS extension for the macOS platform.

The method 300 proceeds to step 308, where the method 300 determines whether there are any new products or updates the user has not viewed. The method 300 compares the list of new products and updates to the viewing history. If the user has viewed all of the new products and updates, the method 300 proceeds to step 320 and ends.

However, if at step 308, the method 300 determines that there are new products or updates that the user has not yet viewed, the method 300 proceeds to step 310. At step 310, the method 300 displays the new products and/or updates that the user has not viewed. The method 300 proceeds to step 312.

At step 312, the method 300 determines whether the user is done viewing new products and updates. The user may select a new product or update in order to view more information. When the user selects the new product or update and views the information, the method 300 proceeds to step 314, where the method 300 updates the viewing history to indicate the viewed product or update. The method 300 proceeds to step 312 and iterates until the user indicates that the user is done viewing new products and updates. The user may indicate that the user is done by, for example, selecting a “DONE” button in a graphical user interface, or closing the window where the new products and updates are displayed. When, at step 312, the method 300 determines that the user is done viewing new products and updates, the method 300 proceeds to step 316.

At step 316, the method 300 stores the viewing history. The method 300 sends the viewing history to the software provider's server. For example, the method 300 calls a recordProductsNUpdatesMetadata API that causes the software provider's server to store the updated viewing history in the user's account.

The method 300 proceeds to step 318 and ends.

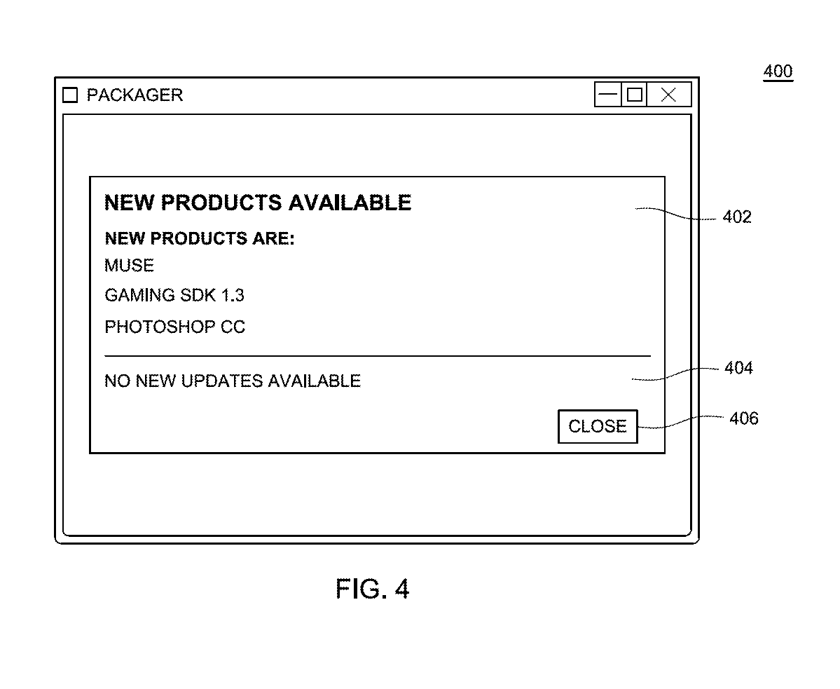

FIG. 4 illustrates a screen shot of a window 400 for displaying new products and updates that have not been viewed by the user, according to one embodiment. As described in FIG. 3, above, a list of new products and updates that are available from a software provider is compared to a user's viewing history. The window 400 includes a new products pane 402 and a new updates pane 404. The new products and updates that have not been viewed by the user are displayed. The new products pane 402 includes a list of new products that have not been viewed by the user. The new updates pane 404 includes a list of new updates that have not been viewed by the user. The new products available and listed in the new products pane 402 include Muse, Gaming SDK 1.2 and PHOTOSHOP CC. As can be seen in the new updates pane 404, no new Updates are available from the software provider that the user has not already viewed. The user may select each new product to view more information about the product. When the user is done, and for example, clicks the close button 406, an updated viewing history is sent to the server. When the user logs in again, the viewed products are not displayed again in the new product pane 402 because the viewing history indicates that the products have already been viewed.

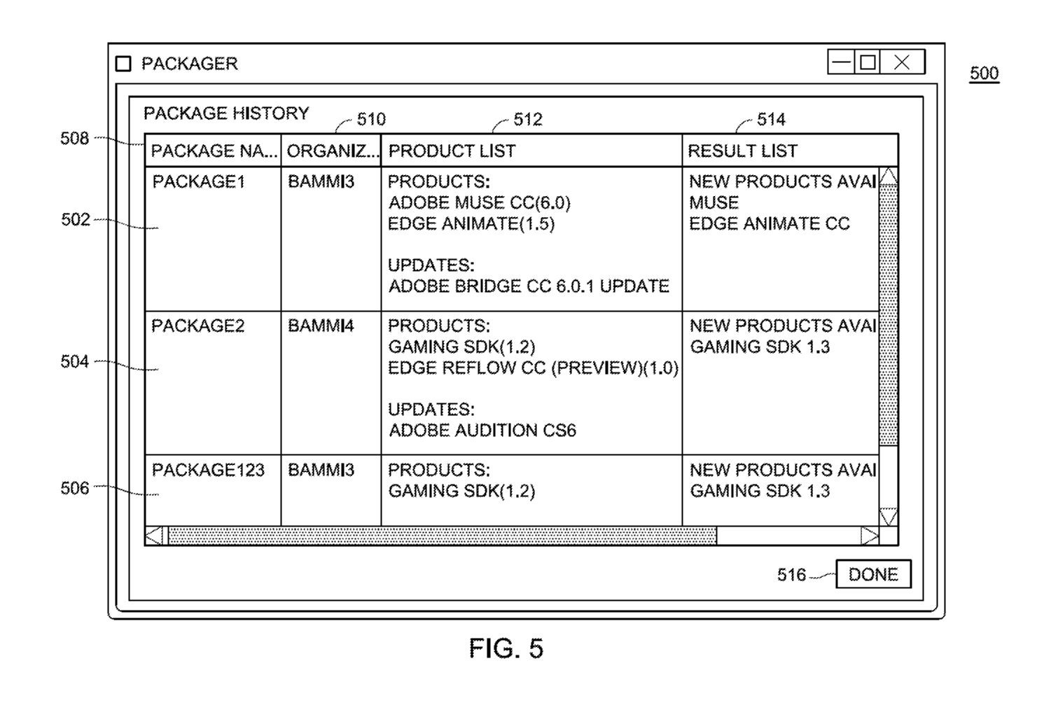

FIG. 5 illustrates a screen shot of a window 500 for displaying software packages with available updates, according to one embodiment. The software packages 502, 504, and 506, are packages identified in the package history of the user. The window 500 displays a package name 508, an organization 510, a product list 512, and a result list 514 for each software package 502, 504, 506. The package name 508 is a name of the software package 502, 504, 506. The organization 510 is the organization for which the software package is built. The product list 512 includes a list of each product and update that was bundled in the software package 502, 504, 506. The result list 514 is the list of new products and updates that are available for the products in the product list 512. Software package 502 has new versions of products Muse and Edge Animate CC available. Software package 504 has a new version of Gaming SDK available, as does software package 506.

The user may select one or more software packages 502, 504, 506 that have new versions available and click the “DONE” button 516. Clicking the “DONE” button 516 causes the updated software to be downloaded, the package history to be updated and sent to the software provider server, and the software package to be bundled in to a single unit that is ready for installation on an end user device.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
receiving, at a first device from at least one server, a package history, a viewing history, and a list of new available products,
wherein the package history indicates one or more software packages previously bundled for installation on one or more end user devices, each end user device being remote from the first device, and each software package comprising one or more products, and
wherein the viewing history indicates products previously provided for display to a user of the first device;
based on the viewing history, the package history, and the list of new available products, providing for display to the user via the first device at least one new available product, wherein the at least one new available product has not previously been provided for display to the user;
downloading the at least one new available product to the first device; and
bundling the at least one new available products to create a new software package for installation on the one or more end user devices; and
updating the viewing history and the package history.

2. The method of claim 1,
wherein the one or more products comprise at least one of a software application or a software update, and
wherein the at least one new available product comprises at least one of a new software application or a new software update.

3. The method of claim 2, further comprising
comparing the list of new available products to the package history to determine one or more software packages related to the at least one new available product.

4. The method of claim 2, further comprising:
retrieving the list of new available products from a software provider; and
retrieving the viewing history from the software provider.

5. The method of claim 2, further comprising:
comparing the list of new available products to the viewing history to determine the at least one new available product, wherein the at least one new available product has not previously been provided for display to the user.

6. The method of claim 1, further comprising:
sending the updated viewing history and the updated package history to one or more servers.

7. The method of claim 1, wherein providing for display the at least one new available product further comprises:
providing one or more software packages for display; and
indicating at least one software package from the one or more software packages is related to the at least one new available product.

8. A system comprising:
at least one processor; and
at least one non-transitory computer readable storage media storing instructions thereon that, when executed by the at least one processor, cause the system to:
receive, at a first device from at least one server, a package history, a viewing history, and a list of new available products,
wherein the package history indicates one or more software packages previously bundled for installation on one or more end user devices, each end user device being remote from the first device, and each software package comprising one or more products, and
wherein the viewing history indicates products previously provided for display to a user of the first device;
compare the viewing history and the list of new available products to identify at least one new available product that has not previously been provided for display to the user;
compare the package history and the list of new available products to identify one or more software packages that is related to the at least one new available product;
provide for display to the user via the first device the at least one new available product that is related to the one or more software packages and that has not previously been provided for display to the user;
download, to the first device, the at least one new available product; and
bundle the at least one new product available to create a new software package for installation on the one or more end user devices.

9. The system of claim 8,
wherein the one or more products comprise at least one of a software application or a software update, and
wherein the at least one new available product comprises at least one of a new software application or a new software update.

10. The system of claim 9, further comprising instructions that, when executed by the at least one processor, cause the system to:
retrieve the list of new available products from a software provider; and
retrieve the package history from the software provider.

11. The system of claim 9, further comprising instructions that, when executed by the at least on processor, cause the system to:
update the package history; and
send the updated package history to one or more servers.

12. The system of claim 9, further comprising instructions that, when executed by the at least one processor, cause the system to:
retrieve the list of new products available from a software provider; and
retrieve the viewing history from the software provider.

13. The system of claim 9, further comprising instructions that, when executed by the at least on processor cause the system to:
update the viewing history; and
send the updated viewing history to one or more servers.

14. A computer implemented method comprising:
receiving, at a first device from at least one server, a package history, a viewing history, and a list of new available products,
wherein the package history indicates one or more software packages previously bundled for installation on one or more end user devices, each end user device being remote from the first device, and each software package comprising one or more products, and
wherein the viewing history indicates products previously provided for display to a user of the first device;
comparing the viewing history and the list of new available products to identify at least one new available product that has not previously been provided for display to the user;
comparing the package history and the list of new available products to identify one or more software packages that is related to the at least one new available product;
providing for display to the user via the first device the at least one new available product that is related to the one or more software packages and that has not previously been provided for display to the user;
downloading, to the first device, the at least one new available product; and
bundling the at least one new available products to create a software package for installation on the one or more end user devices.

15. The computer readable medium of claim 14, wherein the one or more products comprise at least one of a software application or a software update, and
wherein the at least one new available product comprises at least one of a new software application or a new software update.

16. The method of claim 15, wherein providing for display further comprises:
providing one or more software packages for display; and
indicating the one software package related to the at least one new available product.

17. The method of claim 14, further comprising:
updating the package history; and
causing the updated package history to be stored by the software provider.

18. The method of claim 15, further comprising:
retrieving the list of new products available from the software provider; and
retrieving the viewing history from the software provider.

19. The method of claim 14, further comprising:
updating the viewing history; and
causing the updated viewing history to be stored by the software provider.

20. The method of claim 14, wherein bundling the at least one new available product causes the at least one new available product to no longer be considered a new available product at a later time.
